(19) United States
(12) Patent Application Publication
(10) Pub. No.: US 2024/0123677 A1
(43) Pub. Date: Apr. 18, 2024

(54) PAPER PULP INSTALLATION TRAY

(71) Applicant: NLU Products, L.L.C., Lehi, UT (US)

(72) Inventor: Jordan Melville, Lehi, UT (US)

(21) Appl. No.: 18/458,016

(22) Filed: Aug. 29, 2023

Related U.S. Application Data
(60) Provisional application No. 63/401,989, filed on Aug. 29, 2022.

(51) Int. Cl. B29C 63/02; B29C 63/00

(52) U.S. Cl. CPC B29C 63/02; B29C 63/0004; B29C 2063/0008; B29L 2031/3475

(57) ABSTRACT

An installation tray for installing screen protectors on mobile devices is formed from a paper pulp material. The paper pulp material used to form the installation tray can include a blend of sugar cane bagasse and bamboo. The installation tray can include a base structure and a lip. The base structure and lip can define an indentation for receiving a mobile device. The indentation can prevent movement of the mobile device during installation of the screen protector. The installation tray can further include a first pair of studs and a second pair of studs for aligning the screen protector with respect to a mobile device. The installation tray can be part of an assembly which includes a screen protector, installation accessories, and packaging components.

### CROSS REFERENCE TO RELATED APPLICATIONS

This application claims the benefit of U.S. Provisional Patent Application No. 63/401,989, filed on Aug. 29, 2022 which is incorporated by reference herein.

### BACKGROUND

Screens of mobile devices are susceptible to scratching due to contact with sharp objects during normal use, such as rubbing against keys in a pocket. Mobile device screens can also crack due to impacts, such as when the mobile devices are dropped. Adding screen protectors to mobile devices can reduce accidental damage to their screens. Screen protectors may be formed of a thin tempered glass or polymer film with an adhesive backing. The screen protector is oriented on the screen and provides additional protection of the screen from damage, such as scratches and impact fractures. Careful orientation during installation is desirable to avoid misplaced screen protectors which can leave protector edges extending beyond a curvature of the device or otherwise provide an undesirable visual skew.

### SUMMARY

An installation tray can facilitate the installation of screen protectors on mobile devices. The installation tray can include a base structure and a lip. The base structure and lip form an indentation configured and dimensioned to receive a mobile device. The indentation prevents lateral movement of the mobile device to facilitate the installation of a screen protector. The base structure can include a finger hole to facilitate removal of the mobile device from the indentation.

In an embodiment, the installation tray, including the base structure and the lip, can be formed of a paper pulp material. In an embodiment, the paper pulp material comprises sugar cane bagasse. In an embodiment, the paper pulp material comprises bamboo. In an embodiment, the paper pulp material comprises a blend of sugar cane bagasse and bamboo. In another embodiment, this blend can comprise a ratio of 60% sugar cane bagasse and 40% bamboo.

In an embodiment, the installation tray can include a first pair of studs on the top of the tray and a second pair of studs on the bottom of the tray. The first and second pair of studs provide an alignment feature for aligning a screen protector with a screen of a mobile device installed into the indentation. The first pair of studs and the second pair of studs can be oriented at opposing sides along an upper surface of the lip, although any number and orientation of studs can be suitable guide for alignment. In such cases, a corresponding extended complementary tab can allow for alignment. The extended tabs can include receiving holes which conformably fit with the studs. The extended tabs can be part of a cap sheet oriented across a front surface of the screen protector, or directly attached to the screen protector as two separate pieces, with a removable pressure sensitive adhesive.

Another aspect includes an assembly or kit for facilitating the installation of a screen protector on a mobile device. The assembly or kit can include an installation tray that facilitates the installation of screen protectors on mobile devices by holding the mobile devices in place. The installation tray can include a base structure and a lip. The base structure and lip form an indentation configured and dimensioned to removably receive a mobile device. The indentation prevents lateral movement of the mobile device to facilitate the installation of a screen protector. The base structure can include a finger hole to facilitate removal of the mobile device from the indentation. The installation tray, including the base structure and the lip, can be formed of a paper pulp material. In some examples, the base structure and the lip can be formed of two separate pieces which are connected or bonded together. Alternatively, the base structure and the lip can be formed as a single contiguous part.

In an embodiment, the paper pulp material comprises sugar cane bagasse. In an embodiment, the paper pulp material comprises bamboo. In an embodiment, the paper pulp material comprises a blend of sugar cane bagasse and bamboo. In an embodiment, this blend can comprise a ratio of 60% sugar cane bagasse and 40% bamboo. In an embodiment, the installation tray can include a first pair of studs on the top of the tray and a second pair of studs on the bottom of the tray. The first and second pair of studs provide an alignment feature for aligning a screen protector with a screen of a mobile device installed into the indentation.

The assembly or kit can further include one or more of a cleaning wipe, a lint-free cloth, and dust removal stickers positioned with the installation tray beneath a paper cover. The assembly or kit can further include a screen protector disposed in the installation tray. The dimensions of the screen protector may vary depending on the brand and model of the mobile device. The screen protector can include a removable backing film which can be removed to expose an adhesive layer for adhering to the device screen, and an optional front cap sheet which can protect a front face of the screen protector prior to and during installation. The installation tray provides rigidity to the packaging, thereby protecting the contents, and also serves as a tool to install and orient the screen protector on the mobile device.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is an exploded view of an assembly for installing a screen protector onto a mobile device according to an embodiment of the present disclosure.

FIG. 2A is a top view of an installation tray with a mobile device according to an embodiment of the present disclosure.

FIG. 2B is a cross-section view of the installation tray with a mobile device taken along the section A-A shown in FIG. 2A.

FIG. 2C is a top side view of the installation tray with a mobile device shown in FIG. 2A.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### Definitions

In describing and claiming the present invention, the following terminology will be used.

The singular forms “a,” “an,” and “the” include plural referents unless the context clearly dictates otherwise. Thus, for example, reference to “a stud” includes reference to one or more of such features and reference to “removing” refers to one or more of such method steps.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, the term “about” is used to provide flexibility and imprecision associated with a given term, metric or value. The degree of flexibility for a particular variable can be readily determined by one skilled in the art. However, unless otherwise enunciated, the term “about” generally connotes flexibility of less than 2%, and most often less than 1%, and in some cases less than 0.01%.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of.” For example, “at least one of A, B and C” explicitly includes only A, only B, only C, or combinations of each.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

As used herein, the term “mobile device” refers to portable electronic equipment that includes a screen as part of an electronic display. For example, a mobile device can include one of the various makes and models of cell phones, smart phones, tablets, handheld gaming devices, music players, and the like. Their screens can be formed of glass or other material susceptible to damage.

As used herein, the term “screen protector” refers to a thin sheet of protective material that can be attached to the screen of an electronic device. A screen protector can be made of made of a transparent material including, but not limited to, laminated tempered glass, polyethylene terephthalate (PET), thermoplastic polyurethane (TPU), or the like.

As used herein, the term “paper pulp material” refers to fibrous materials such as sugarcane bagasse, bamboo, wheat straw, wood chips, wood fibers, recycled paperboard, recycled newsprint, and combinations of these materials. In some cases, the paper pulp material can also be a non-recycled plant source, e.g. sugarcane bagasse, bamboo, wheat straw, and the like.

### Example Embodiments

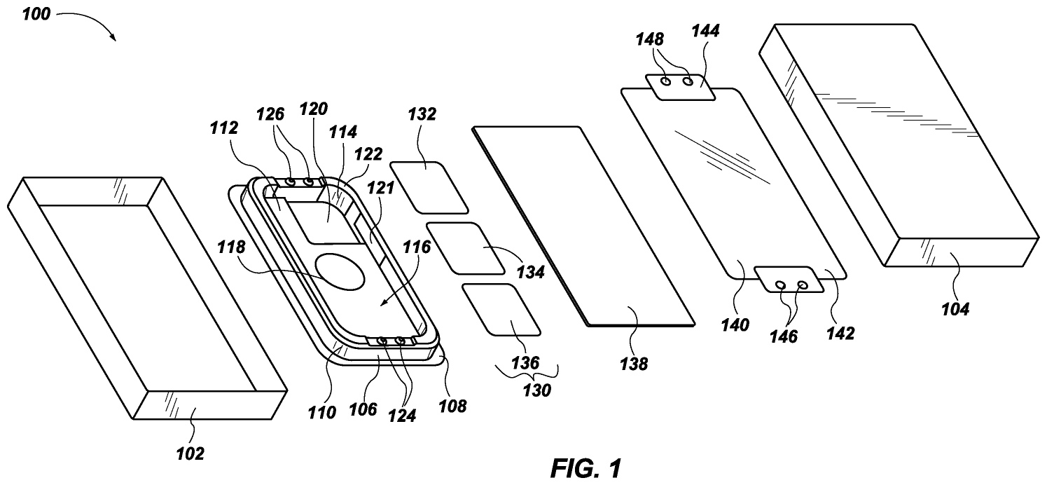

Referring to FIG. 1, there is shown an assembly 100 according to an embodiment of the present disclosure for facilitating the installation of a screen protector 140 on a mobile device (not shown). The assembly 100 can include a container 102 having a top lid 104. In an embodiment, the container 102 can be a box. The top lid 104 can be slightly larger than the container 102 such that it slips over the container 102.

The assembly 100 can further include an installation tray 106 sized to fit in the container 102. The installation tray 106 can include a base structure 108. A lip 110 can extend upwardly from the base structure 108 to form a circumferential wall. An inner surface 112 of the base structure 108 and an inner sidewall 114 of the lip 110 define an indentation 116. The indentation 116 can have a height, width and depth similar to the dimensions of a mobile device such that the mobile device is removably installable into the indentation 116. That is, the mobile device can be received into indentation 116 such that lateral movement of the mobile device is restricted. Although the lip is illustrated as a continuous circumferential sidewall, the indentation can also be defined by a segmented circumferential wall (i.e. in multiple parts with gaps) as long as the mobile device is restrained from lateral movement when engaged within the indentation 116. In an embodiment, the dimensions of the indentation 116 can be varied based upon the make and the model of the mobile device. That is, the dimensions of the indentation 116 can be adapted to retain at least one particular mobile device including dimensions of depth, width, length, corner radius of curvature, etc.

The inner surface 112 of the base structure 108 can include a finger hole 118. It will be appreciated that the finger hole 118 can be utilized to allow a user to push the mobile device out of the indentation 116 from the backside of the installation tray 106. The inner surface 112 of the base structure 108 can further include a recessed portion 120 or opening. The recessed portion 120 or opening can be configured and dimensioned to receive lenses on a mobile device, which may extend beyond the bottom surface of the mobile device. It will be appreciated that the recessed portion 120 allows a mobile device to lie flat in the indentation 116. The inner sidewall 114 of the lip 110 can also include one or more recessed portion(s) 121 to accommodate buttons extending from a side of a mobile device and to provide additional access points to assist in removing the device from the installation tray 106.

A top surface 122 of the lip 110 can include a first pair of studs 124 and a second pair of studs 126. The first pair of studs 124 can be located along a top edge of the lip 110 above the indentation 116 and the second pair of studs 126 can be located along a bottom edge of the lip 110. As will be explained below, the first pair of studs 124 and the second pair of studs 126 can be utilized to align the screen protector 140 over a mobile device installed into the indentation 116. Of course, a single pair of studs may be sufficient to orient the screen protector 140, although studs oriented at locations remote from one another or opposite from one another (i.e. top to bottom or left to right) provides additional security in achieving proper alignment.

The assembly 100 can further include accessories 130 to facilitate the installation of the screen protector 140 onto a mobile device. The accessories 130 can include an alcohol cleaning wipe 132, a lint-free cloth 134, and dust removal stickers 136. Prior to use, the accessories 130 can be positioned and stored in the indentation 116. A paper cover 138 can be utilized to cover and secure the accessories 130 inside of the indentation 116. That is, the paper cover 138 can be dimensioned to fit within the indentation 116.

The screen protector 140 can be dimensioned to fit a screen of a mobile device. It will be appreciated that the dimensions of the screen protector 140 can vary dependent on the make and model of the mobile device. A first tab 142 and a second tab 144 can be attached to a bottom and top of the screen protector 140, respectively. Alternatively, the first tab 142 and the second tab 144 can be integrally formed with or attached to a cap sheet (not shown) which laminates a front face of the screen protector 140. Such a cap sheet can be a thin polymer film which is removable and functions to protect the screen protector surface prior to and during installation, and which is removed after installation is completed. The first tab 142 can include a first pair of alignment bores 146. The second tab 144 can include a second pair of alignment bores 148. During the installation process, the first pair of alignment bores 146 receive the first pair of studs 124 and the second pair of alignment bores 148 receive the second pair of studs 126. In this manner, the bores (146 and 148) in cooperation with the studs (124 and 126) properly align the screen protector 140 with respect to a mobile device placed into the indentation 116. Thus, it can be desirable to have a very small tolerance of movement between the bores and the studs (i.e. not allowing for movement at all or typically less than about 0.5 mm or less than about 0.2 mm).

When the assembly 100 is fully assembled, the installation tray 106, accessories 130, cover 138 and screen protector 140 fit into the container 102 with the top lid 104 installed. The accessories 130 can be sandwiched between the cover 138 and the inner surface 112 of the base structure 108. The screen protector 140 can be sandwiched between the cover 138 and the top lid 104, and in some cases can be laid within the indentation 116.

In an embodiment, the installation tray 106, including the base structure 108 and the lip 110, can be formed from a paper pulp material. As a non-limiting example, the installation tray 106 can be formed by wet molding paper pulp material using a press mold. In another aspect, the wet molding process can include binding additives during preparation of a paper pulp mixture to increase fiber adhesion. Further, an optional post-molding step can include coating the molded tray with a binder coating. Such a binder coating can create a thin film which further adheres fibers and reduces presence of loose fibers, while also providing an increase in surface smoothness compared to traditional paper pulp processing which can be relatively rough. The wet molding can further optionally include air jets and vacuuming to remove loose paper fibers that remain during and after the molding process. In these cases, surfaces of the molded installation tray can be largely free of protruding, loose, or extended fibers. Such fibers can be particularly undesirable during installation of a screen protector where loose debris can become lodged between the device screen and adhesive layer of the screen protector. Such lodged debris tends to create an air bubble around the debris which is unsightly and may reduce touchscreen responsiveness.

In an embodiment, the paper pulp material comprises fibrous organic material. In another embodiment, the paper pulp material comprises sugar cane bagasse. In still another embodiment, the paper pulp material comprises 60% sugar cane bagasse. In still another embodiment, the paper pulp material comprises bamboo and sugar cane bagasse. In still another embodiment, the paper pulp material comprises a blend of 60% sugar cane bagasse and 40% bamboo. In another embodiment, the paper pulp material used to form the installation tray 106 comprises bamboo. In still another embodiment, the paper pulp material comprises 40% bamboo. In another example, the paper pulp material can comprise one or more of wheat straw, wood chips, and wood fibers. In still another example, recycled materials can be used such as recycled paperboard, recycled newsprint, and the like. In other words, the paper pulp material can be formed of sugarcane bagasse, bamboo, wheat straw, wood chips, wood fibers, recycled paperboard, recycled newsprint, and combinations of these materials.

A thin protective coating can be applied to the installation tray 106 to prevent fibers from coming loose from the installation tray to form dust particles which can become lodged in the adhesive layer during installation. The protective coating can comprise an acrylic, paraffin wax, polyurethane, or the like. The coating can be applied to the installation tray 106 using a spray process during manufacture of the installation tray. It will be appreciated that the presence of dust particles is undesirable during the installation of the screen protector 140 onto a mobile device.

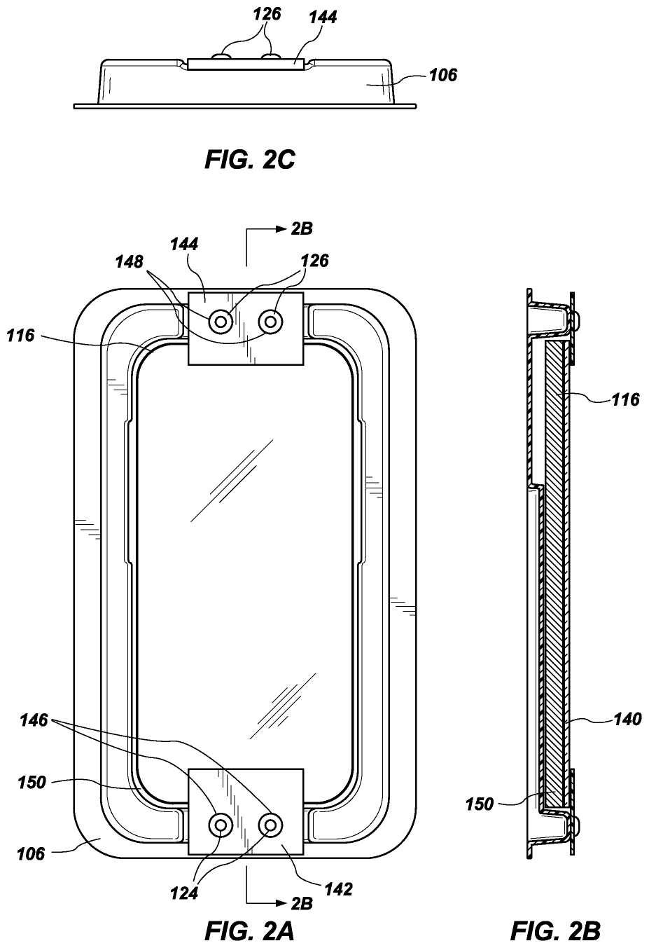

Referring to FIGS. 2A-2C, where like reference numerals depict like components, a mobile device 150 can be placed in the indentation 116 on the installation tray 106. The indentation 116 can hold the mobile device 150 such that it is fixed in position relative to the installation tray 106. The accessories 130 (see FIG. 1) can be used to prepare the screen of the mobile device 150, including removing any dust on the screen of the mobile device 150. A backing film (not shown) can be peeled from a back surface of the screen protector 140 exposing a pressure sensitive adhesive layer. The screen protector 140 is then placed onto the screen of the mobile device 150 where the adhesive layer removably bonds with the surface of the device screen. The alignment bores 146 and 148 on the tabs 142 and 144, respectively, are placed onto the studs 124 and 126, respectively, to ensure alignment between the screen protector 140 and the mobile device 150. After the screen protector 140 has been installed, the mobile device 150 can be removed using the finger hole (118 in FIG. 1). The installation tray 106 can then be reused, recycled or discarded. Advantageously, the paper pulp material allows for biodegradability over a relatively short period of time compared to traditional plastic installation trays which tend to persist in the environment. Thus, regardless of whether the paper pulp tray is recycled or sent to a landfill, degradation occurs to reduce or eliminate environmental impact.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. An installation tray for installing a screen protector on a mobile device, comprising:
a base structure having a lip, the base structure and the lip defining an indentation configured to receive a mobile device therein;
wherein the indentation is dimensioned to prevent lateral movement of the mobile device and wherein the base structure and the lip are formed from a paper pulp material.

2. The installation tray of claim 1, wherein the paper pulp material comprises sugar cane bagasse.

3. The installation tray of claim 2, wherein the paper pulp material comprises 60% sugar cane bagasse.

4. The installation tray of claim 2, wherein the paper pulp material further comprises bamboo.

5. The installation tray of claim 1, wherein the paper pulp material comprises bamboo.

6. The installation tray of claim 5, wherein the paper pulp material comprises 40% bamboo.

7. The installation tray of claim 1, wherein the paper pulp material comprises 60% sugar cane bagasse and 40% bamboo.

8. The installation tray of claim 1, further comprising a first pair of studs and a second pair of studs configured to align a screen protector with respect to a mobile device.

9. The installation tray of claim 8, wherein the first pair of studs and the second pair of studs are oriented at opposing sides along an upper surface of the lip.

10. The installation tray of claim 1, wherein the base structure comprises a hole.

11. An assembly for installing a screen protector on a mobile device, comprising:
an installation tray, comprising:
a base structure having a lip, the base structure and the lip defining an indentation configured to receive a mobile device therein, and
the indentation dimensioned to prevent lateral movement of the mobile device;
wherein the installation tray is formed from a paper pulp material;
a cover positioned with the installation tray; and
one or more of a cleaning wipe, lint-free cloth, and dust removal stickers positioned within the installation tray and beneath an optional paper cover.

12. The assembly of claim 11, further comprising a screen protector.

13. The assembly of claim 11, wherein the paper pulp material comprises sugar cane bagasse.

14. The assembly of claim 13, wherein the paper pulp material comprises 60% sugar cane bagasse.

15. The assembly of claim 13, wherein the paper pulp material further comprises bamboo.

16. The assembly of claim 11, wherein the paper pulp material comprises bamboo.

17. The assembly of claim 16, wherein the paper pulp material comprises 40% bamboo.

18. The assembly of claim 11, wherein the paper pulp material comprises 60% sugar cane bagasse and 40% bamboo.

19. The assembly of claim 11, further comprising a first pair of studs and a second pair of studs configured to align a screen protector with the mobile device.

20. The assembly of claim 11, wherein the base structure and the lip are formed of a single contiguous part.
